(19) United States
(12) Patent Application Publication
(10) Pub. No.: US 2026/0097301 A1
(43) Pub. Date: Apr. 9, 2026

(54) DYNAMIC REAL-TIME WIND SIMULATION FOR VIRTUAL RACING

(71) Applicant: Lenovo (United States) Inc., Morrisville, NC (US)

(72) Inventors: James LaCroix, Morrisville, NC (US); Nicolas Allebrodt, Morrisville, NC (US); Axel Ramirez, Morrisville, NC (US)

(21) Appl. No.: 18/908,583

(22) Filed: Oct. 7, 2024

(51) Int. Cl. A63F 13/285

(52) U.S. Cl. CPC A63F 13/285

(57) ABSTRACT

In one aspect, a device includes a processor system and storage accessible to the processor system. The storage includes instructions executable by the processor system to facilitate a racing simulation. The instructions are also executable to, as part of facilitating the racing simulation, simulate wind in real time as the racing simulation transpires. The wind is simulated in real time based on one or more variable inputs associated with the racing simulation, such as virtual vehicle velocity and virtual weather indicated in the racing simulation. The wind may be simulated both virtually in the simulation itself as well physically in the real-world by using fans to direct air toward the user.

### FIELD

The disclosure below relates to technically inventive, non-routine solutions that are necessarily rooted in computer technology and that produce concrete technical improvements. In particular, the disclosure below relates to dynamic real-time wind simulation for virtual racing.

### BACKGROUND

As recognized herein, current input and output modalities related to computer simulations are limited and can be improved.

### SUMMARY

Accordingly, in one aspect a device includes a processor system and storage accessible to the processor system. The storage includes instructions executable by the processor system to facilitate a racing simulation. The instructions are also executable to, as part of facilitating the racing simulation, simulate wind in real time as the racing simulation transpires. The wind is simulated in real time based on one or more variable inputs associated with the racing simulation.

In one example, the instructions may be executable to execute a model to receive the one or more variable inputs and to generate, based on the one or more variable inputs, an inference indicating the wind to simulate.

Thus, in one particular non-limiting instance, the instructions may be executable to, responsive to the inference indicating the wind to simulate, simulate the wind virtually in the racing simulation. The wind may be simulated virtually by moving a virtual vehicle inconsistent with user control of the virtual vehicle. E.g., the instructions may be executable to move the virtual vehicle in the racing simulation according to a cross-wind impinging on the virtual vehicle.

In addition to or in lieu of the foregoing, the instructions may be executable to, responsive to the inference indicating the wind to simulate, simulate the wind in the real-world by controlling an output device to produce wind in a direction of a user. If desired, the device may even include the output device, which itself may include one or more fans or other air drivers. Thus, in various examples the instructions may be executable to control the output device to simulate the wind proportional to a virtual speed of a virtual vehicle controlled by the user as part of the racing simulation, and/or to simulate the wind proportional to a cross-wind indicated by the racing simulation.

In various example implementations, the one or more variable inputs may be provided by a simulation engine that executes the racing simulation.

Also in various example implementations, the device may include an electronic race car in which a user can sit while playing the racing simulation.

In another aspect, a method includes facilitating a racing simulation and, as part of facilitating the racing simulation, simulating wind in real time as the racing simulation transpires. The wind simulated in real time based on one or more variable inputs associated with the racing simulation.

In some non-limiting examples, the wind may be simulated virtually in the racing simulation based on both virtual weather indicated by the racing simulation and virtual velocity of a virtual vehicle being controlled by a user to participate in the racing simulation. Additionally or alternatively, the wind may be simulated in the real-world using one or more output devices to drive air in a direction of a user.

Also, in some examples the method may include executing a model to receive the one or more variable inputs and to generate, based on the one or more variable inputs, an inference indicating the wind to simulate.

In still another aspect, at least one computer readable storage medium (CRSM) that is not a transitory signal includes instructions executable by a processor system to facilitate a racing simulation. The instructions are also executable to, as part of facilitating the racing simulation, simulate first wind in real time as the racing simulation transpires. The first wind is simulated in real time based on one or more inputs associated with the racing simulation.

In some instances, the instructions may be executable to execute a model to receive the one or more inputs and to generate, based on the one or more inputs, an inference indicating the first wind to simulate.

Also in some instances, the instructions may be executable to simulate the first wind virtually in the racing simulation.

Additionally or alternatively, the first wind may be real-world wind, and here the instructions may be executable to simulate the first wind in the real-world by controlling one or more fans to direct air in a first direction toward a user. The first direction may correspond to a second direction in the racing simulation at which virtual second wind impinges a virtual vehicle being controlled by the user to participate in the racing simulation.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of an example extended reality (XR) headset consistent with present principles;

FIG. 4 is a perspective view illustration of an example electronic racecar in which a user can sit while playing a racing simulation consistent with present principles;

FIG. 5 shows example logic in example flow chart format that may be executed during a racing simulation to simulate wind virtually and/or in the real-world consistent with present principles;

FIGS. 6 and 7 show example graphical user interfaces (GUIs) that may be presented on a display responsive to a racing simulation ending consistent with present principles;

FIG. 8 shows example logic in example flow chart format that may be executed to configure a machine learning (ML) model consistent with present principles;

FIG. 9 shows example software architecture that may be implemented consistent with present principles; and

FIG. 10 shows an example settings GUI that may be presented to configure one or more settings of a device, app, and/or hardware race car simulator to operate consistent with present principles.

### DETAILED DESCRIPTION

Among other things, the detailed description below describes devices and methods that connect racer biometrics and sensor data to provide a next generation AR/VR racing simulation experience. Thus, a cutting-edge, no-latency AR/VR racing simulation experience is provided with the use of sensors fused with racer biometrics data using artificial intelligence and/or deep learning. In one specific example, a convolutional neural network (CNN) and deep learning algorithm/deep learning approach may be used for multimodal biometric and sensor recognition.

Sensors that may be involved include vitals biometric sensor(s) on the wrist, camera(s) for eye tracking inside the virtual headset, and microphones for voice control.

Motion controls may also be used, with a tactical and haptic feedback system fused with racer biometrics data using AI/deep learning.

Additionally, race control real-time telemetry may be fused with racer biometrics data, voice commands, and eye positioning. Human real-time vitals monitoring may be used consistent with present principles (e.g., heart rate, oxygen levels, pupil dilation, body temperature).

As mentioned herein, use cases include not just gaming but training, educational (e.g., totally virtual), deliveries, simulations of real life activities, etc. (part real life, part virtual).

Therefore, in one particular aspect, an adaptive wind simulation engine may be implemented. The system may use real-time data from the simulation, including vehicle speed, direction, and environmental conditions to dynamically adjust the simulated wind conditions experienced by the human racer. The engine can simulate varying wind speeds, gusts, and directions, closely mirroring the unpredictability of real-world racing environments.

To convey the wind simulation to the racer physically, the system may include advanced feedback mechanisms, such as directionally-controlled airflow units positioned around the racer. These units can vary the intensity and direction of airflow directed at the user to simulate the effect of wind on the vehicle and the driver’s body in a real-world race, enhancing the realism of the experience.

The system can also model the interaction between the vehicle’s aerodynamics and the simulated wind conditions, adjusting vehicle handling and performance characteristics as impacted by wind in real-time within the simulation itself. This allows racers to experience and learn how to counteract aerodynamic effects such as lift, drag, and crosswind instability.

Recognizing the diverse needs and preferences of users, the wind simulation system may also offer customizable settings. Racers can adjust the intensity, variability, and types of wind conditions they wish to train against, tailoring the simulation to specific training goals or racing scenarios.

Example use cases include, but are not limited to, the following: Enhanced training for professional racers; Professional racers using AI to analyze their performance in different simulated wind conditions to help them understand the optimal handling and aerodynamic adjustments needed for a variety of racing environments; Simulated wind conditions, varying in intensity and direction, to challenge racers to adapt their strategies, with AI providing feedback on performance improvement and areas needing focus; Educational tools for aerodynamics; AI aids in simulating realistic wind effects on vehicles, allowing students and enthusiasts to visually and tactilely grasp the principles of aerodynamics and how they impact vehicle performance; Adapting the difficulty and complexity of wind scenarios based on the user’s learning progress, offering a customized educational experience that evolves over time; Increased immersion for sim racing enthusiasts with AI-driven wind simulation to enhance the realism of the racing experience by dynamically adjusting to the virtual environment, vehicle speed, and direction, thereby mirroring the unpredictable nature of real-world racing conditions; Using AI to recreate historical weather conditions from notable races, providing enthusiasts with the opportunity to experience famous races with added realism, making the simulation itself more engaging and enjoyable.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

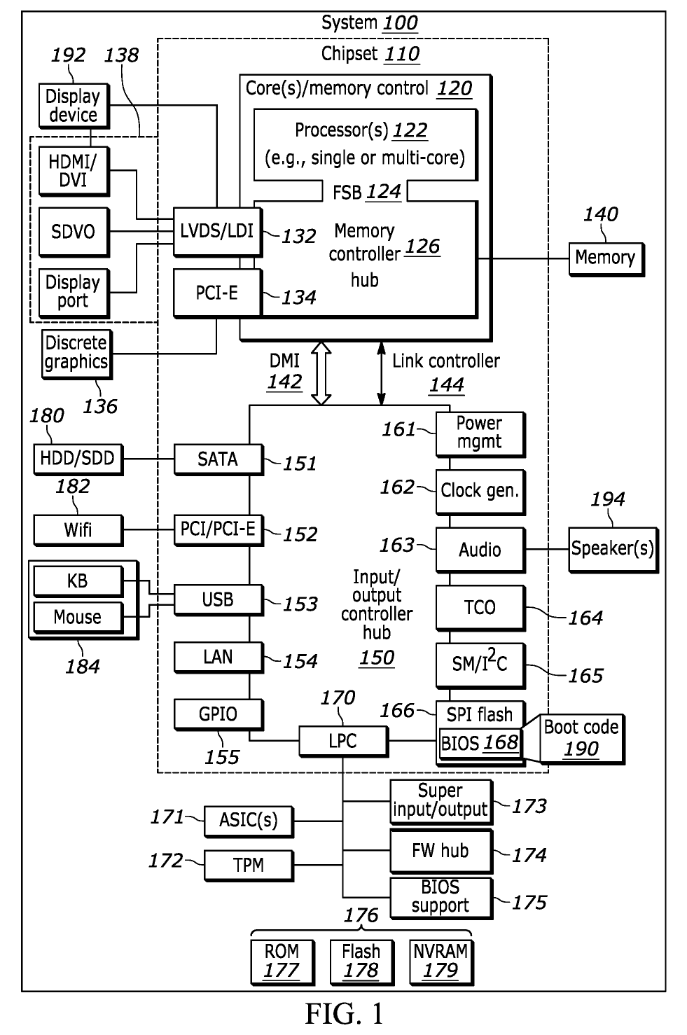

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

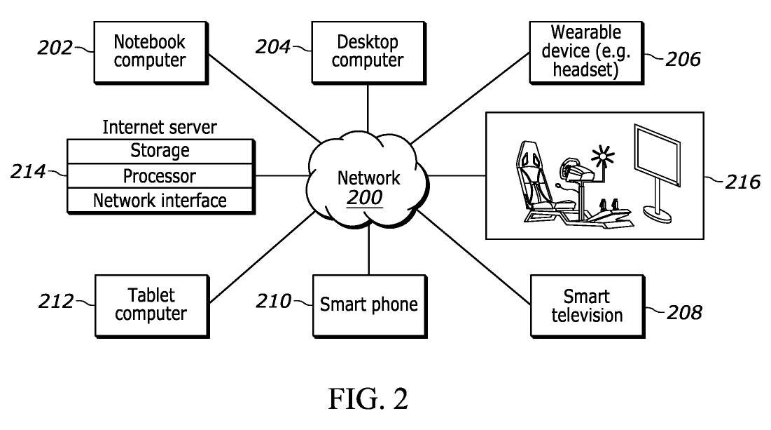

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch or XR headset, a smart television (TV) 208, a smart phone 210, a tablet computer 212, an electronic race car 216 in which a user can sit while playing a racing simulation, and a server 214 such as an Internet server that may provide cloud storage accessible to the devices 202-212, 216. It is to be understood that the devices 202-216 may be configured to communicate with each other over the network 200 to undertake present principles.

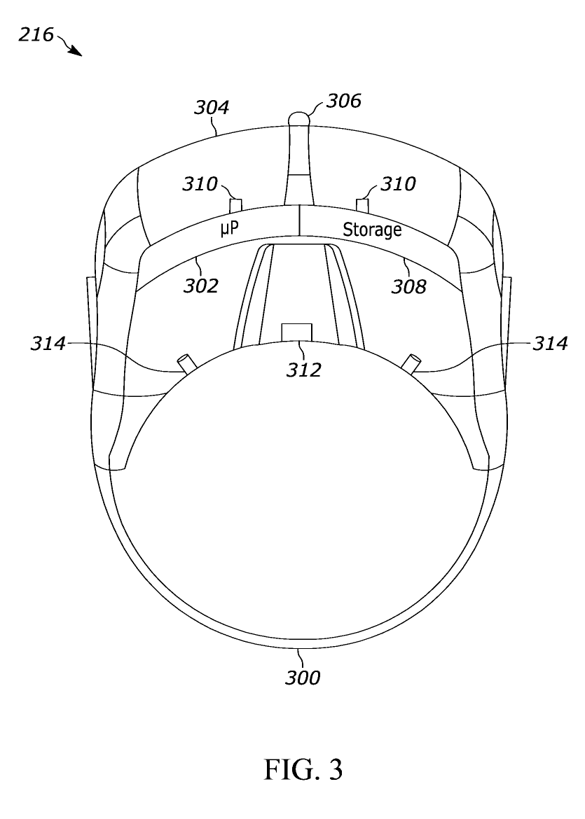

Now describing FIG. 3, it shows a top plan view of a headset, such as the headset 206, consistent with present principles. The headset 206 may be used to present audio and/or video of the racing simulation at the headset’s speakers and display while other input/output is provided via the electronic race car 216.

The headset 206 may include a housing 300, at least one processor assembly 302 in the housing 300, and a non-transparent or transparent “heads up” display 304 accessible to the at least one processor assembly 302 and coupled to the housing 300. The display 304 may for example have discrete left and right eye pieces as shown for presentation of stereoscopic images and/or 3D virtual images/objects using augmented reality (AR) software, virtual reality (VR) software, and/or mixed reality (MR) software (more generally, extended reality (XR) software). The display 304 may thus present visual content related to the racing simulation.

The headset 206 may also include one or more forward-facing cameras 306. As shown, the camera 306 may be mounted on a bridge portion of the display 304 above where the user’s nose would be so that it may have an outward-facing field of view similar to that of the user himself or herself while wearing the headset 206. The camera 306 may be used for computer vision, image registration, spatial mapping, etc. to identify biometrics and other data as described herein and/or to track user movements within real-world space. However, further note that the camera(s) 306 may be located at other headset locations as well. Further note that in some examples, inward-facing cameras 310 may also be mounted within the headset 206 and oriented to image the user’s eyes for eye tracking while the user wears the headset 206 consistent with present principles.

Additionally, the headset 206 may include storage 308 accessible to the processor assembly 302 and coupled to the housing 300, a microphone 312 for detecting audio of the user speaking to provide voice commands to the racing simulation and detecting audio biometric data consistent with present principles (e.g., detecting excitement in the user’s voice). The headset 206 may include additional biometric sensors 314 as well, such as a heart rate sensor, an oxygen level sensor, and/or a body temperature sensor.

The headset 206 may include still other components not shown for simplicity, such as a network interface for communicating over a network such as the Internet and a battery for powering components of the headset 206 such as the camera(s) 306. The headset 206 may also include one or more speakers for presenting audio of the racing simulation. Additionally, note that while the headset 206 is illustrated as a head-circumscribing VR headset, it may also be established by computerized smart glasses or another type of headset including other types of AR and MR headsets. For example, the headset may be established by an AR headset that may have a transparent display that is able to present 3D virtual objects/content.

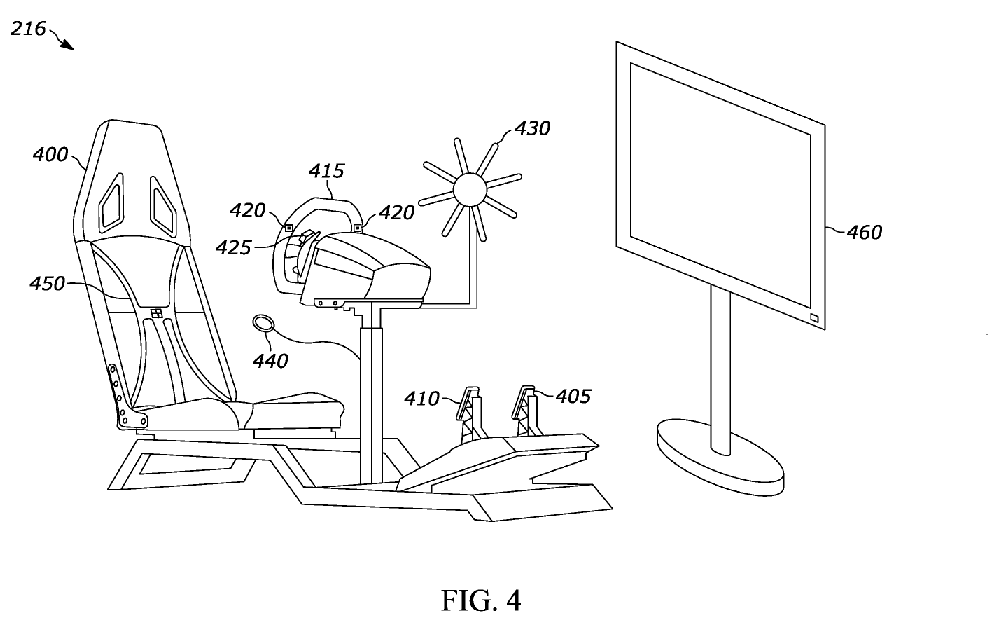

As mentioned above, the headset 206 may also communicate with the electronic race car 216 and/or a remotely-located server such as the server 214 to execute/facilitate a racing simulation consistent with present principles. The race car 216 is shown in greater detail in FIG. 4. As shown in this figure, the race car 216 may include a seat 400 in which a user can sit. The electronic race car may also include an electronic gas pedal 405 and an electronic brake pedal 410, either of which may be pushed forwards and released backwards by the user using his/her foot to either accelerate or decelerate/brake a virtual vehicle being controlled by the user as part of the racing simulation (via control of the real-life electronic pedals 405, 410). The pedals 405, 410 may thus include one or more sensors such as infrared (IR) proximity sensors, potentiometers, pressure sensors, position sensors, etc. to sense movement of the pedals 405, 410 to thus provide associated input to the racing simulation.

As also shown in FIG. 4, an electronic steering wheel 415 may also be included on the device 216. The steering wheel may include one or more vibrators 420 at different locations on the steering wheel 415 to create haptic/force feedback consistent with present principles. Each vibrator 420 may be established by, for example, an electric motor connected to an off-center and/or off-balanced weight via the motor’s rotatable shaft so that the shaft may rotate under control of the motor (which in turn may be controlled by a processor assembly such as the assembly 122) to create vibration of various frequencies and/or amplitudes as well as force simulations in various directions.

The steering wheel 415 may also include a potentiometer 425 or other type of sensor to sense turning of the steering wheel 415 while the user plays the racing simulation.

As also shown, the device 216 may include one or more electronic fans 430 including respective motors controllable by the device to increase and decrease the speed of the fans 420 to create wind proportional to the speed of a virtual race car being controlled by the user as part of the racing simulation to thus simulate wind that might be experienced by a real-life racer while racing in real-life.

In some examples, the fans 430 may also be on electronically-controllable circular or semi-circular tracks to move in the horizontal plane around the user as the user sits in the seat 400 to direct air toward the user from various angles/directions consistent with the disclosure below. Additionally or alternatively, the fans may be located on electronically-controllable robot arms to move both vertically and horizontally relative to the user to direct air toward the user consistent with the disclosure below. Either way, note that one or more electronically-controllable buffers such as slats around the exterior front of each fan may be used to direct air from the fan at one angle or another toward the user consistent with the disclosure below.

Note that in addition to or in lieu of fans, other output devices may also be used to similarly generate air flow, including blowers and bladeless air movers.

As also shown in FIG. 4, the device 216 may further include a wired or wireless wearable device 440 that may be engaged with a user’s wrist or other body part to sense one or more biometrics of the user. Thus, the device 440 may include a heart rate sensor, an oxygen level sensor, a body temperature sensor, and/or another type of sensor for providing biometric input to a system operating consistent with present principles.

As also shown in FIG. 4, the device 216 may include a five-point active, electronic seatbelt with active tensioner 450 that anchors to the seat 400 at five respective locations, such as above each shoulder, to the side of each hip, and in between the legs. The active seatbelt tensioner may be another type of seatbelt tensioner as well, such as a two-point or three-point active seatbelt tensioner. Each anchor point of the seatbelt 450 may be coupled to a motorized spool in the seat 400 that forms part of the tensioner, with the spool configured to extend and retract the respective strap from that anchor point under control of a processor system consistent with present principles. Thus, each of the five straps of five-point tensioner 450 may be independently extendable via a respective spool to lengthen the strap to decrease tension of the strap against the user, and independently retractable via the respective spool to shorten the strap to increase tension of the strap against the user.

As also shown in FIG. 4, the device 216 may include a display 460 on which visual content may be presented. The visual content may include real-time video of the racing simulation as well as the GUIs described below. Note that the headset display may additionally or alternatively present the same content.

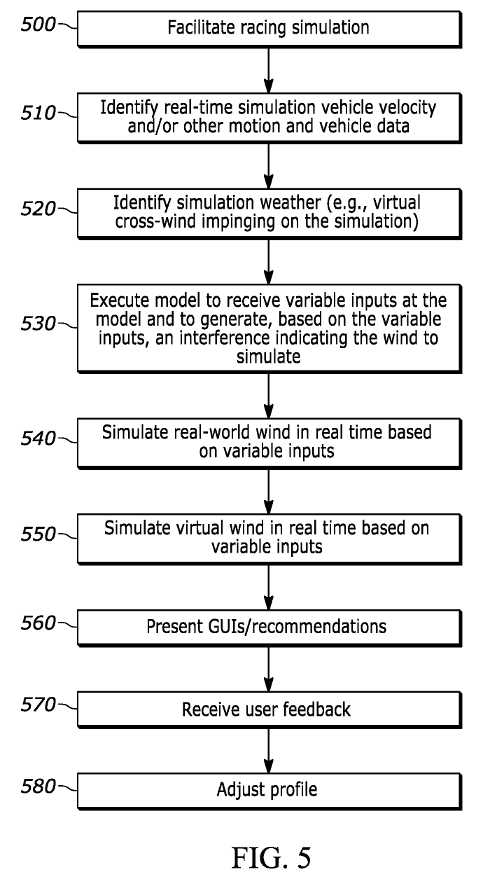

With FIGS. 1-4 having been described, it is to be understood that a user’s experience in a vehicle racing simulation may be enhanced through several operations performed by a device/system, which may include a processor system executing a set of codes to control functional elements of a real-life racing apparatus such as the e-vehicle 216. Accordingly and now referring now to FIG. 5, it shows example logic that may be executed by a device such as the system 100, headset 206, server 214, and/or electronic race car 216 alone or in any appropriate combination consistent with present principles. Note that while the logic of FIG. 5 is shown in flow chart format, other suitable logic may also be used.

Beginning at block 500, the device may facilitate (e.g., execute) a virtual racing simulation where a person/end-user races a first virtual race care (more generally, first simulation vehicle) against other virtual race cars on a virtual race track. The other race cars might be controlled by other human players/users, and/or autonomously by the simulation system itself.

But before the user’s virtual race starts, in some examples at block 500 the device may also load a vehicle profile into the simulation engine. The profile may have metrics for the particular real-world high-performance vehicle chosen by the user to race virtually in the racing simulation. Thus, it is to be understood that different sim (virtual) cars may be used that are based on different real-world high-performance vehicles whose metrics have been incorporated into the simulation so that the corresponding virtual vehicles perform similarly to the real-world counterparts (but in the virtual race) in the wind. The metrics themselves may include vehicle exterior/body dimensions, vehicle max acceleration and max speed metrics, vehicle acceleration change over time and speed change over time metrics, etc. This data may be provided to a machine learning (ML) model as will be described later.

From block 500, the logic may then proceed to block 510. At block 510 the device may identify one or more variable inputs related to the racing simulation. In one example, physics data for the first simulation vehicle may establish some of the variable inputs. The physics data may be received from the simulation engine that executes the simulation itself. The physics data may be used to identify real-time simulation vehicle velocity and acceleration, real-time virtual tire traction (e.g., whether the virtual vehicle is drifting), real-time terrain data for virtual terrain underneath and around the virtual vehicle, real-time braking data for application of the first simulation vehicle’s virtual brakes, real-time virtual vehicle collision data (collisions with other virtual vehicles or other virtual objects around the virtual racetrack), and other types of real-time data related to the performance and wind resistance of the first simulation vehicle during the virtual race.

The logic may then proceed to block 520. At block 520 the device may identify variable inputs related to simulation weather, such as virtual cross-winds, tailwinds, and/or headwinds impinging on the first simulation vehicle virtually as part of the simulation. This data may also be provided by the simulation engine.

From block 520 the logic may then proceed to block 530. At block 530 the device may provide the vehicle profile data loaded at block 500 and variable input data identified at blocks 510 and 520 to a model executed by (or at least accessible to) the simulation engine. Then at block 540 the device may execute the model to receive the one or more variable inputs at the model and to generate, based on the one or more variable inputs (including the vehicle profile data), an inference indicating wind to simulate.

For example, the inference may indicate control signals to drive one or more real-world fans (or other output devices) to simulate the simulation wind in the real-world. The fans may therefore drive real-world air in directions toward the user that match wind approach angles toward the first simulation vehicle in the simulation itself. The wind angles may be provided by the simulation engine.

Thus, in one particular example, the device may use the control signals at block 540 to simulate the virtual wind in real time, simulating first wind in the real-world by controlling the fans to direct air in a first direction toward the user that corresponds to a second direction in the racing simulation at which virtual second wind impinges the first simulation vehicle. Thus, the real and simulation winds may be mapped to come from the same direction relative to the forward-facing parallel axes of the real-world user and virtual vehicle.

Additionally or alternatively, at block 550 the system may use an inference from the model to simulate wind virtually in the racing simulation based on the one or more variable inputs. This may include simulating wind virtually by moving the first simulation vehicle inconsistent with user control of the vehicle in the simulation, such as moving the vehicle to the left according to a cross-wind impinging on the vehicle from the right while the user also tries to turn the vehicle to the right.

Notwithstanding the foregoing example, further note that acceleration winds may also be simulated virtually (and in the real-world), as may deceleration winds, braking winds, and vehicle drifting and other traction loss-related winds. Variable-direction winds due to vehicle collisions may also be simulated (collision of the user’s vehicle with another vehicle or other virtual object).

Thus, note more generally that wind may be simulated virtually in the simulation proportional to weather indicated in the racing simulation, such as proportional to a cross-wind impinging on the first simulation vehicle virtually according to the racing simulation. The wind that is simulated virtually may also be proportional to a current virtual speed of the first simulation vehicle. Thus, in one particular example, the wind may be simulated virtually based on both virtual weather indicated by the racing simulation and virtual velocity of the first simulation vehicle.

Likewise, wind may be simulated in the real-world proportional to weather indicated in the racing simulation, such as proportional to a cross-wind impinging on the first simulation vehicle virtually according to the racing simulation. The wind that is simulated in the real-world may also be proportional to a current virtual speed of the first simulation vehicle. Thus, in one particular example, the wind may be simulated in the real-world based on both virtual weather indicated by the racing simulation and virtual velocity of the first simulation vehicle.

Further note that the model that is executed at block 530 may be an artificial intelligence (AI) model, such as a machine learning (ML) model in particular. The model may therefore include, in one particular non-limiting example, one or more convolutional neural networks (CNN) configured for pattern recognition based on different types of racing simulation variable inputs and vehicle profiles.

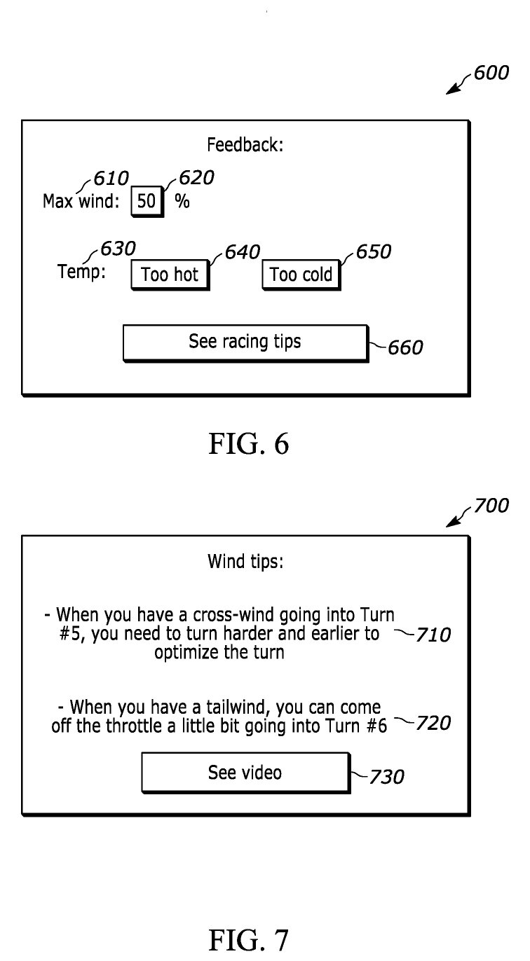

After block 550 the logic may then proceed to block 560. At block 560 the device may present one or more graphical user interfaces (GUIs) on a display viewable to the user, including to provide recommendations of how the user might improve their wind-related driving performance in the future. For example, the GUIs of FIGS. 6 and 7, which will be described shortly, may be presented at block 560 responsive to the racing simulation ending (e.g., virtual racing concluding).

From block 560 the logic may then proceed to block 570. At block 570 the device may receive user feedback on the wind that was produced virtually and/or in the real-world. The feedback may be received through the GUI of FIG. 6 as described later.

After block 570 the logic may proceed to block 580. At block 580 the device may adjust the user’s electronic racing profile based on the feedback received at block 570. For instance, the user may wish to decrease the amount of real-world or virtual wind that is simulated according to the variable inputs from the simulation engine. Or the user might indicate that the temperature of the wind that was produced in the real-world was too hot or too cold. This data may therefore be saved to the user’s profile to produce wind according to the user’s preferences in the future.

FIG. 6 further illustrates. As shown, a GUI 600 may be presented responsive to the racing simulation ending so that the user themselves can provide feedback to the racing simulation system. The GUI 600 may therefore include a first section 610 at which the user may set a particular maximum wind to simulate in the real-world and/or virtually. Here, the user may do so by entering numerical input into input box 620 to establish a max wind as a percentage of the system’s absolute maximum real or virtual wind.

The GUI 600 may also include a second section 630 at which the user can indicate whether the wind that was produced in the real-world was too hot (selector 640) and/or too cold (selector 650). Thus, it is to be understood that heaters, air conditioners, and other heat-modulating real-world output devices may be used in combination with one or more fans 430 to direct hot and cold air toward the user.

Therefore, after a race in which the hot and cold air was directed toward the user, the user may provide feedback regarding whether the hot air was too hot and whether the cold air was too cold, which may then be provided as feedback that gets saved to the user’s profile at block 580 as mentioned above. The profile may then be applied in future races to drive hot and cold air according to the user’s preferences in subsequent sim races.

FIG. 6 also shows that the GUI 600 may include a selector 660. The selector 660 may be selected to command the system to present racing tips to the user based on the user’s performance in the recent simulation race. Accordingly, selection of the selector 660 may cause the GUI 700 of FIG. 7 to be presented.

As shown in FIG. 7, the GUI 700 may include first and second driving tips 710, 720 as output by the simulation engine based on the user’s wind-related driving control in the sim race as compared to an optimal performance under the same wind-related driving conditions. Thus, tip 710 may indicate a first turning technique to the user, such as, “When you have a cross-wind going into Turn #5, you need to turn harder and earlier to optimize the turn.” The tip 720 may then indicate a second turning technique to the user, such as, “When you have a tailwind, you can come off the throttle a little bit going into Turn #6.”

In some non-limiting examples, the GUI 700 may also include a selector 730. The selector 730 may be selectable to command the device to present a video of one or both optimal turning techniques according to the tips 710, 720. In one particular example, a multi-modal generative video model may be executed to produce the video, with the text-based tips 710, 720 and actual simulation video from the simulation the user just finished being provided as input to the generative video model for the model to generate synthetic video not from the actual simulation (and/or sim engine) but from the generative video model itself. But owing to the inputs that were provided to the generative video model, the generative video itself may still show the same race portions as participated in by the user but as driven according to the optimal turning techniques.

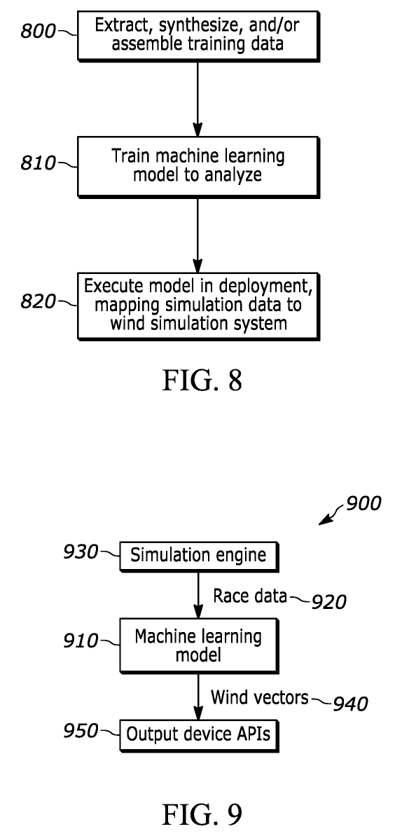

Now in reference to the example logic of FIG. 8, it is to be understood that artificial intelligence (AI)-assisted data generation and processing may be used to accurately replicate the dynamic wind forces experienced during real-world racing scenarios while executing a simulation race. Thus, advanced AI systems may be deployed to extract and synthesize comprehensive data from sources like real-world in-car footage, real-world telemetry logs, and real-world air sensor readings. Machine learning models may be trained to analyze this multi-modal data to then identify intricate patterns and relationships between the various inputs and the corresponding wind forces exerted on the real-life vehicles in the real-life driving situations. Thus, supervised learning, self-learning, unsupervised learning, reinforcement learning, and other deep learning techniques may be used to train the model based on this data. The trained model can then be used to simulate real and virtual wind during deployment, enabling an unparalleled degree of congruence between the virtual simulation and the experiences of real-life professional race drivers. Additionally, the AI model’s ability to continuously learn and refine its inferences from an ever-expanding dataset of high-performance vehicles can also help the system remain aligned with the latest real-world conditions and vehicle wind dynamics.

With this understanding in mind, reference is now made to FIG. 8. At block 800, the system may extract, synthesize, and/or assemble the aforementioned training data. The dataset of training data may include ground truth wind velocity (speed and direction vectors) along with vehicle profile data and race inputs (like acceleration, braking, weather-related wind striking the vehicle, etc.) from different real-world driving scenarios. Then at block 810 the system may train the machine learning (ML) AI-based model to analyze the data and provide inferences of real and/or virtual wind to simulate for a given in-race event/type.

From block 810 the logic of FIG. 8 may then proceed to block 820. At block 820 the system may execute the ML model during deployment consistent with the logic of FIG. 5. The system may thus map simulation data to simulated real-world wind and virtual wind according to its learning from the real-world race scenarios.

Continuing the detailed description in reference to FIG. 9, this figure shows example software architecture 900 that may be implemented consistent with present principles. Therefore, note that an ML model 910 according to FIG. 8 may receive race data and vehicle profile data 920 from a simulation engine 930.

The ML model 910 may then analyze the data 920 to provide an output 940 of dynamic real-world and/or virtual wind vectors to apply as part of the racing simulation (based on whatever variable inputs were provided by the simulation engine 930). Thus, the vectors may be used to control real-world fans via one or more fan application programming interfaces (APIs) 950 to direct air toward the user at real-world angles that correspond to virtual angles at which virtual wind impinges on the user’s vehicle in the simulation itself. Additionally, the vectors may be used by the system to move the user’s virtual vehicle in the simulation itself according to virtual wind indicated by the vectors so that the vehicle moves inconsistent with the user’s control of the vehicle within the simulation.

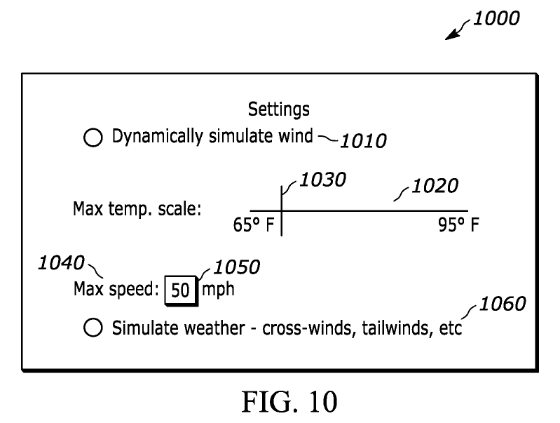

Now in reference to FIG. 10, this figure shows an example GUI 1000 that may be presented on a display for an end-user to configure one or more settings of an apparatus, racing simulation app, and/or electronic racecar to operate consistent with present principles. Each option discussed below may be selected by selecting the respective radio button shown adjacent to each option, whether through cursor input, touch input, or another type of input.

As shown in FIG. 10, the GUI 1000 may include an option 1010 that is selectable to set or configure the device to undertake present principles. Therefore, in one example, selection of the option 1010 a single time may configure the device to, for multiple future racing simulations, execute the functions described above in reference to FIGS. 5-9. The option 1010 may be accompanied by one or more other controls.

For example, the GUI 1000 may include a scale 1020 with slider 1030 so that the user can slide the slider 1030 left and right along the scale 1020 to decrease or increase maximum temperature of real-world wind directed toward the user (on a Fahrenheit temperature scale of sixty five to ninety five per this example). Thus, the user may control the max wind temperature to his/her comfort level as the user engages in racing simulations in the future. The GUI 1000 may also include a setting 1040 at which the user can enter a max real-world wind speed to use by specifying a particular number via number entry box 1050 as expressed in miles per hour.

FIG. 10 also shows that the GUI 1000 may include an option 1060. The option 1060 may be selectable to specifically configure the system to simulate weather-related wind (in addition to wind from virtual vehicle acceleration, deceleration, etc.). Again, weather-related winds may include cross-winds from various angles that are orthogonal to or obtuse to the longitudinal axis of the virtual vehicle, as well as headwinds and tailwinds.

It may now be appreciated that racing simulations consistent with present principles provide realistic feedback in sim racing, providing environmental realism in sim racing through real-world and virtual winds. Racing simulations may thus account for the dynamic and unpredictable nature of real-world racing conditions, particularly in terms of how wind affects vehicle performance and handling. This in turn may provide racers with useful environmental details that could be encountered on an actual real-world race track with a real-world racecar. Racers are thus provided with the experience of real-world challenges related to vehicle aerodynamics but in a virtual environment, including challenges related to drafting off (behind) other vehicles, wind resistance, and the impact of crosswinds on vehicle stability. Thus, the simulation with real and virtual winds can track closely to real-world race scenarios, reflecting the complex interaction between the vehicle and real-world conditions like wind speed, direction, and turbulence.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
facilitate a racing simulation;
as part of facilitating the racing simulation, simulate wind in real time as the racing simulation transpires, the wind simulated in real time based on one or more variable inputs associated with the racing simulation.

2. The device of claim 1, wherein the instructions are executable to:
execute a model to receive the one or more variable inputs and to generate, based on the one or more variable inputs, an inference indicating the wind to simulate.

3. The device of claim 2, wherein the instructions are executable to:
responsive to the inference indicating the wind to simulate, simulate the wind virtually in the racing simulation.

4. The device of claim 3, wherein the instructions are executable to:
simulate the wind virtually by moving a virtual vehicle inconsistent with user control of the virtual vehicle.

5. The device of claim 3, wherein the instructions are executable to:
move the virtual vehicle in the racing simulation according to a cross-wind impinging on the virtual vehicle.

6. The device of claim 2, wherein the instructions are executable to:
responsive to the inference indicating the wind to simulate, simulate the wind in the real-world by controlling an output device to produce wind in a direction of a user.

7. The device of claim 6, comprising the output device.

8. The device of claim 7, wherein the output device comprises one or more fans.

9. The device of claim 6, wherein the instructions are executable to:
control the output device to simulate the wind proportional to a virtual speed of a virtual vehicle controlled by the user as part of the racing simulation.

10. The device of claim 6, wherein the instructions are executable to:
control the output device to simulate the wind proportional to a cross-wind indicated by the racing simulation.

11. The device of claim 1, wherein the one or more variable inputs are provided by a simulation engine that executes the racing simulation.

12. The device of claim 1, comprising an electronic race car in which a user can sit while playing the racing simulation.

13. A method, comprising:
facilitating a racing simulation;
as part of facilitating the racing simulation, simulating wind in real time as the racing simulation transpires, the wind simulated in real time based on one or more variable inputs associated with the racing simulation.

1414 The method of claim 13, wherein the wind is simulated virtually in the racing simulation based on both virtual weather indicated by the racing simulation and virtual velocity of a virtual vehicle being controlled by a user to participate in the racing simulation.

15. The method of claim 13, wherein the wind is simulated in the real-world using one or more output devices to drive air in a direction of a user.

16. The method of claim 13, comprising:
executing a model to receive the one or more variable inputs and to generate, based on the one or more variable inputs, an inference indicating the wind to simulate.

17. At least one computer readable storage medium (CRSM) that is not a transitory signal, the at least one CRSM comprising instructions executable by a processor system to:
facilitate a racing simulation;
as part of facilitating the racing simulation, simulate first wind in real time as the racing simulation transpires, the first wind simulated in real time based on one or more inputs associated with the racing simulation.

18. The at least one CRSM of claim 17, wherein the instructions are executable to:
execute a model to receive the one or more inputs and to generate, based on the one or more inputs, an inference indicating the first wind to simulate.

19. The at least one CRSM of claim 18, wherein the instructions are executable to:
simulate the first wind virtually in the racing simulation.

20. The at least one CRSM of claim 19, wherein the first wind is real-world wind, and wherein the instructions are executable to:
simulate the first wind in the real-world by controlling one or more fans to direct air in a first direction toward a user, the first direction corresponding to a second direction in the racing simulation at which virtual second wind impinges a virtual vehicle being controlled by the user to participate in the racing simulation.
